(19) United States
(12) Patent Application Publication
(10) Pub. No.: US 2014/0040962 A1
(43) Pub. Date: Feb. 6, 2014

(54) AUDIO WIRELESS TRANSMISSION SYSTEM AND WIRELESS TRANSMISSION METHOD

(71) Applicant: Samsung Electro-Mechanics Co., Ltd., Gyeonggi-do (KR)

(72) Inventor: Byong Hyok Choi, Gyeonggi-do (KR)

(73) Assignee: SAMSUNG ELECTRO-MECHANICS CO., LTD., Gyeonggi-do (KR)

(21) Appl. No.: 13/954,945

(22) Filed: Jul. 30, 2013

(30) Foreign Application Priority Data
Jul. 31, 2012 (KR) 10-2012-0083927

(51) Int. Cl. H04N 21/61

(52) U.S. Cl. CPC H04N 21/6106
USPC 725/74

(57) ABSTRACT

Disclosed herein are an audio wireless transmission system including: a video device broadcasting and transmitting audio signal through an industrial scientific medical (ISM) band frequency; and a wireless terminal sensing the ISM band frequency transmitted from the video device and demodulating the audio signal so as to listen to the audio signal, and an audio wireless transmission method using the same, in order for each individual to receive audio signal of a video device in a public place through a wireless terminal possessed by each individual and listen to the audio signal.

### CROSS REFERENCE(S) TO RELATED APPLICATIONS

This application claims the benefit under 35 U.S.C. Section 119 of Korean Patent Application Serial No. 10-2012-0083927, entitled “Audio Wireless Transmission System and Wireless Transmission Method” filed on Jul. 31, 2012, which is hereby incorporated by reference in its entirety into this application.

### BACKGROUND OF THE INVENTION

1. Technical Field

The present invention relates to an audio wireless transmission system and wireless transmission method, and more particularly, to an audio wireless transmission system using an industrial scientific medical (ISM) band frequency and an audio wireless transmission method using the same.

2. Description of the Related Art

In the case in which a video is transmitted through a plurality of video devices such as a television in a public place such as an airport, a terminal waiting room, a large hospital, or the like, a sound is provided in a mute state or very small volume for convenience of the public.

Therefore, since people viewing the television in the public place should view only the video displayed on the television and presume content thereof, it is difficult to appreciate the content in which the video is desired to deliver. Alternatively, although subtitles corresponding to a video screen are displayed, there is a limit as to what the content of the video is livelily delivered only using the subtitles.

As such, the video device disposed in the public place has a problem that a natural object of the video device needing to deliver the content of the video and public ethics which is a public convenience are completely conflicted with each other, such that a method capable of solving the problem has been urgently demanded.

### SUMMARY OF THE INVENTION

An object of the present invention is to provide an audio wireless transmission system of wirelessly transmitting audio signal of a video device to various wireless terminals possessed by an individual using an ISM band frequency and an audio wireless transmission method using the same.

According to an exemplary embodiment of the present invention, there is provided an audio wireless transmission system, including: a video device broadcasting and transmitting audio signal through an industrial scientific medical (ISM) band frequency; and a wireless terminal sensing the ISM band frequency transmitted from the video device and demodulating the audio signal so as to listen to the audio signal.

The video device may include: an audio data generating unit compressing and storing the audio signal of video source in transmittable data; a frequency dividing unit dividing the ISM band frequency into a predetermined frequency bandwidth; a frequency detecting unit searching for an idle frequency among the divided multi-channel frequencies; and a transmitting unit wirelessly transmitting the audio data compressed and stored in the audio data generating unit through the searched idle frequency.

The video device may sequentially assign the number to a plurality of frequency bands divided by the frequency dividing unit and then display the number of the frequency band including the audio data.

The wireless terminal may be any one of a mobile phone, a notebook, a tablet PC, and a PDA capable of transmitting and receiving the ISM band frequency.

According to another exemplary embodiment of the present invention, there is provided an audio wireless transmission method, including: dividing an industrial scientific medical (ISM) band frequency into a predetermined frequency bandwidth; assigning the number to each frequency bandwidth divided by the dividing of the ISM band frequency; searching for an idle frequency band which is not used; broadcasting and transmitting audio data of a video device to a wireless terminal through the idle frequency band searched by the searching of the idle frequency band; and demodulating the audio data received through the wireless terminal.

The audio wireless transmission method may further include, after the broadcasting and transmitting of the audio data, branching to the searching of the idle frequency band when signal strength is a threshold value or less by judging whether or not the signal strength of a frequency band transmitting the audio data is a predetermined threshold value or less per a predetermined period T.

### BRIEF DESCRIPTION OF THE DRAWINGS

FIG. 1 is a basic configuration view of an audio wireless transmission system according to an exemplary embodiment of the present invention;

FIG. 2 is a configuration view schematically showing an inner configuration of the video device included in the exemplary embodiment of the present invention; and

FIG. 3 is a flow chart showing an audio wireless transmission method according to an exemplary embodiment of the present invention.

### DESCRIPTION OF THE PREFERRED EMBODIMENTS

Various advantages and features of the present invention and technologies accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art. Like reference numerals denote like elements throughout the description.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

FIG. 1 is a basic configuration view of an audio wireless transmission system according to an exemplary embodiment of the present invention.

Referring to FIG. 1, an audio wireless transmission system according to an exemplary embodiment of the present invention is largely configured of a video device 100 and wireless terminals 200.

The video device 100 may be all of devices receiving broadcasting signal by including dedicated terminals receiving a component video signal, a super-video home system video signal, and a composite video signal, and the like, and a video signal provided from an external apparatus such as a video player or a DVD player to process the signals, and then displaying a video screen through a display. A typical example of the video device 100 may include a television.

Meanwhile, it is assumed that the video device 100 is provided in a public place such as an airport, a terminal waiting room, a large hospital, or the like.

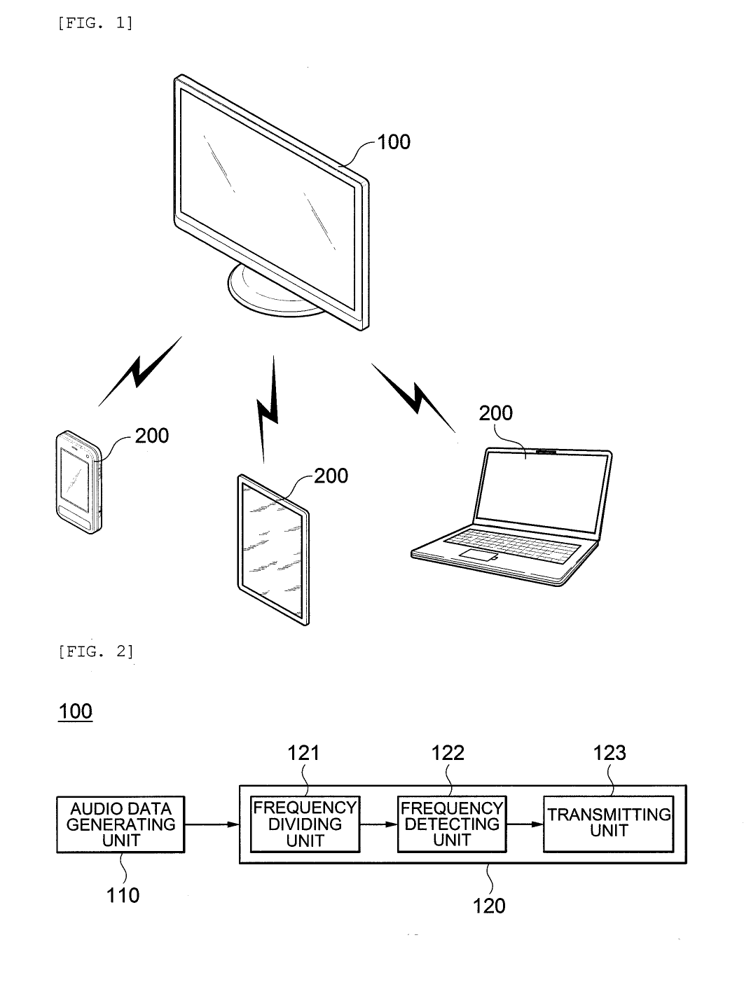

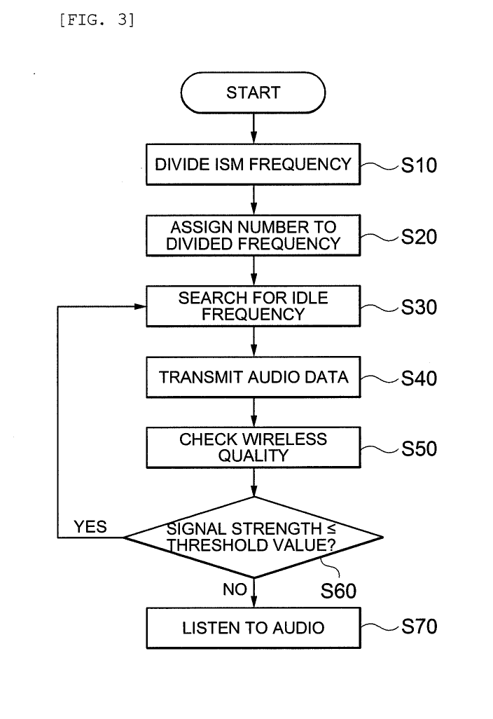

FIG. 2 is a configuration view schematically showing an inner configuration of the video device 100 included in the exemplary embodiment of the present invention. The inner configuration of the video device 100 will be further specifically described with reference to FIG. 2. The video device 100 may include an audio generating unit 110 generating an audio source corresponding to a video source as audio data compressed by a compression method such as an audio coding-3 (AC3), a digital theater system (DTS), a moving picture experts group (MPEG), a dolby trueHD, or the like, in addition to various configuration apparatuses for basically outputting video.

In addition, the video device 100 may include a communicating unit 120 of broadcasting and transmitting the audio data generated from the audio data generating unit 110 to the wireless terminal 200 through an industrial scientific medical (ISM) band frequency.

The ISM band frequency, which is a band assigned to industrial science and medicine using weak electrical field intensity originally unlicensed as a part of the Federal Communications Commission (FCC) rule defined by the United States, mainly uses frequency bands of 900 MHz (902 MHz˜928 MHz), 2.4 GHz (2.4 GHz˜2.4835 GHz), and 5.8 GHz (5.725 GHz˜5.825 GHz). Since the ISM band frequency is a band not requiring a license, it may perform free communication and have characteristics capable of configuring a small scale network.

The communicating unit 120 may include a frequency dividing unit 121, a frequency detecting unit 122, and a transmitting unit 123.

The frequency dividing unit 121 serves to divide all or part of the ISM frequency of 900 MHz (902 MHz˜928 MHz), 2.4 GHz (2.4 GHz˜2.4835 GHz), and 5.8 GHz (5.725 GHz˜5.825 GHz) bands into a predetermined frequency bandwidth, for example, the frequency bandwidth of about 5˜22 KHz.

Among multi-channel ISM frequency bands divided as described above, the frequency detecting unit 122 serves to search for an idle frequency band which is not used, that is, is not occupied by other devices.

The frequency detecting unit 122 may use a cognitive radio (CR) technology capable of sensing an empty frequency band to efficiently share and use the empty frequency band. As an example, the frequency detecting unit 122 may use a channel assignment scheme described in Korean Patent Laid-Open No. 10-2012-0063983.

As such, when a frequency of a suitable ISM band is founded through the frequency dividing unit 121 and the frequency detecting unit 122, the transmitting unit 123 carries and broadcast-transmits the audio data signal generated from the audio data generating unit 110 in the frequency of the detected ISM band.

Therefore, although not shown in the drawing, the transmitting unit 123 may be configured of a power amplifier (PA) for amplifying power to enable signal having sufficient power to be issued, a band-pass filter for transmitting only a desired frequency band, an antenna of finally converting into electrical signal on a conductive wire to perform radiation into electro-magnetic wave in air, and the like.

Again, back to FIG. 1, when the audio data of the video device 100 is transmitted through one of the multi-channel ISM band frequencies divided by the video device 100, a user possessing the wireless terminal 200 converts the audio data received through a RF module in the wireless terminal 200 into an analog sound source and listen to the audio data.

That is, the wireless terminal 200 is located within a distance in which return signal strength indicator (RSSI) of the video device 100 has an effect, so as to operate as a station for the video device 100.

The wireless terminal 200 includes the RF module capable of receiving the ISM band frequency and a demodulator of demodulating the audio data coded in the video device 100, and provides an interface selecting the ISM frequency of specific bandwidth to the user. Therefore, the user individually listens to an audio sound of the video device 100 demodulated by selecting the ISM frequency of a specific band (the ISM frequency including the audio data) by a key input of the interface through a speaker provided in the wireless terminal 200.

A kind of wireless terminal 200, which is a device capable of easily carrying, is not particularly limited as long as the wireless terminal 200 has the RF module capable of transmitting and receiving the frequency of the ISM band. Typically, the wireless terminal 200 may be a smart phone. In addition to that, various kinds of mobile phones, notebooks, and a tablet PCs may also be possible.

Meanwhile, the video device 100 may synchronize video output with audio output of the wireless terminal 200 by set a transmission delay time in advance. That is, the video device 100 may synchronize a video output time with an audio output time of the wireless terminal 200 by setting a suitable delay value before outputting the video in consideration of a signal transmission delay time to the wireless terminal 200.

In addition, the video device 100 may sequentially assign the number to a plurality of frequency bands divided by the frequency dividing unit 121 and display the number of the frequency band including the audio data on the display of the video device 100. The user may easily find the frequency band including the audio data by viewing the number displayed on the display.

Hereinafter, an audio wireless transmission method using the audio wireless transmission system according to an exemplary embodiment of the present invention will be described.

FIG. 3 is a flow chart showing an audio wireless transmission method according to an exemplary embodiment of the present invention.

Referring to FIG. 3, the audio wireless transmission method according to the exemplary embodiment of the present invention first divides the ISM band frequency into the predetermined frequency bandwidths (S10).

Since the ISM band uses 900 MHz (902 MHz˜928 MHz), 2.4 GHz (2.4 GHz˜2.4835 GHz), 5.8 GHz (5.725 GHz˜5.825 GHz) frequency bands, all or part of the ISM frequency band is divided into a bandwidth of about 5˜22 KHz by the frequency dividing unit 121 in the video device 100.

Next, the number is sequentially assigned to the multi-channel ISM frequency bands divided as described above (S20). For example, in the case in which the ISM frequency bands divided according to S10 are 100, assigning a first frequency band to the lowest frequency band and sequentially then assigning the number, the frequency bands from the first frequency band to the hundredth frequency band are generated.

Next, the idle frequency band which is not occupied by other devices among the divided frequency bands (for example, from the first frequency band to the hundredth frequency band) is searched through the cognitive radio (CR) technology (S30) and the audio data generated from the audio data generating unit 110 of the video device 100 is then carried in the searched idle frequency band and is transmitted to the wireless terminal 200 (S40).

The user possessing the wireless terminal 200 may receive the frequency (the idle frequency carrying the audio data) transmitted from the video device 100 and may demodulate the audio data into the analog sound source by a demodulator included in the wireless terminal 200 and listen to the audio data (S70). In this case, the user may easily find the frequency band carrying the audio data by viewing the display of the video device 100.

Meanwhile, after S40, a wireless signal quality check judging whether or not a signal strength of the frequency band transmitting the audio data per a predetermined period T is a threshold value or less may be further performed (S50).

Here, the threshold value means the lowest signal level securing wireless transmission of the frequency including the audio data and it is important to set the threshold value to a suitable value according to a size of the audio data. In addition, in a case of the predetermined period T, when a value thereof is too small, an operation amount of the video device 100 is increased, such that performance of the system may be degraded, and when the value is too large, wireless quality may be degraded. Therefore, the predetermined period T may need to have a suitable value.

When the signal strength of the frequency band transmitting the audio data is the predetermined threshold value or less according to S50, the method is branched to S30 to again search for the idle frequency band and a process transmitting the audio data through the searched idle frequency band is repeated (S60).

Using the audio wireless transmission system and method according to the exemplary embodiment of the present invention as described above, the individual possessing the wireless terminal may wirelessly receive and listen to the audio signal of the video device provided in the public place.

In addition, since the audio signal is transmitted through the ISM band frequency divided into the predetermined band widths by the video device itself and the quality of the wireless signal is checked at an interval of the predetermined period T, the optimal sound quality may be provided.

In accordance with the audio wireless transmission system and method according to the exemplary embodiment of the present invention, each individual may receive and listen to the audio signal of the video device through the wireless terminal possessed by each individual in the public place, thereby making it possible to normally view the video device while contributing to the convenience of the public.

In addition, since the audio signal is transmitted through the ISM band frequency divided into a predetermined band width by the video device itself, optimal sound quality may be provided.

In addition, since the number corresponding to the frequency band carrying audio data is displayed on the display of the video device, a user may easily find the frequency band in which the audio data is contained.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An audio wireless transmission system, comprising:
a video device broadcasting and transmitting audio signal through an industrial scientific medical (ISM) band frequency; and
a wireless terminal sensing the ISM band frequency transmitted from the video device and demodulating the audio signal so as to listen to the audio signal.

2. The audio wireless transmission system according to claim 1, wherein the video device includes:
an audio data generating unit compressing and storing the audio signal of video source in transmittable data;
a frequency dividing unit dividing the ISM band frequency into a predetermined frequency bandwidth;
a frequency detecting unit searching for an idle frequency among the divided multi-channel frequencies; and
a transmitting unit wirelessly transmitting the audio data compressed and stored in the audio data generating unit through the searched idle frequency.

3. The audio wireless transmission system according to claim 2, wherein the video device sequentially assigns the number to a plurality of frequency bands divided by the frequency dividing unit and then displays the number of the frequency band including the audio data.

4. The audio wireless transmission system according to claim 1, wherein the wireless terminal is any one of a mobile phone, a notebook, a tablet PC, and a PDA capable of transmitting and receiving the ISM band frequency.

5. An audio wireless transmission method, comprising:
dividing an industrial scientific medical (ISM) band frequency into a predetermined frequency bandwidth;
assigning the number to each frequency bandwidth divided by the dividing of the ISM band frequency;
searching for an idle frequency band which is not used;
broadcasting and transmitting audio data of a video device to a wireless terminal through the idle frequency band searched by the searching of the idle frequency band; and
demodulating the audio data received through the wireless terminal.

6. The audio wireless transmission method according to claim 5, further comprising, after the broadcasting and transmitting of the audio data, branching to the searching of the idle frequency band when signal strength is a threshold value or less by judging whether or not the signal strength of a frequency band transmitting the audio data is a predetermined threshold value or less per a predetermined period T.
